(19) United States
(12) Patent Application Publication
(10) Pub. No.: US 2019/0321996 A1
(43) Pub. Date: Oct. 24, 2019

(54) PROGRAMMABLE FOOD SLICER WITH DIGITAL SCALE CONTROL

(71) Applicant: Robert Andrew Crawford, Raleigh, NC (US)

(72) Inventor: Robert Andrew Crawford, Raleigh, NC (US)

(21) Appl. No.: 15/961,398

(22) Filed: Apr. 24, 2018

(51) Int. Cl. B26D 7/30; B26D 5/08; B26D 7/06

(52) U.S. Cl. CPC B26D 7/30; B26D 5/086; B26D 2007/0018; B26D 2210/02; B26D 7/0616

(57) ABSTRACT

The present invention is an automatic food slicer with a built-in scale which allows the user to have the slicer automatically stop when a particular weight of food has been sliced.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to electric slicers typically utilized for slicing meat and other food items. In particular, it relates to an automatic electric food slicer with digital scale control.

### Description of Related Art

The use of electric food slicers for cutting deli meats and other foods is well known. The slicer consists of a circular rotating blade and a carriage for holding the food wherein the carriage can press the food toward the rotating blade and reciprocate back and forth either manually or automatically such that the food is sliced and lands on a platform of some kind.

If one is using a manual slicer, the user of the slicer uses hand motion to reciprocate the carriage. The user must stand at the slicer and can do no other work till the slicing is finished. Even standing right there at the slicer, it is difficult, if not impossible, to stop at the right point so as to not over or under slice the amount of food a customer would like since it is only a guess how much has been sliced. An advancement in slicer technology occurred when slicers could automatically reciprocate the carriage, freeing the user to do other things while the food is sliced. However, the machines continue to run and over slicing is a huge problem such that auto slicers have never been universally accepted.

The art teaches that a manual scale could be associated with a slicer but it is designed for use with non-automatic slicers and requires the user to watch the scale instead the food or worse instead of the user's fingers. Appropriately, it appears that such a device was not actually marketed or even actually built.

### BRIEF SUMMARY OF THE INVENTION

The present invention relates to the discovery that a digital scale can be programmed to control an automatic slicer such that the slicer will stop when the required amount of food is sliced. This feature will allow users to walk away from the slicer and know it will stop when a desired weight is achieved.

Accordingly, in one embodiment, there is an automatic electric food slicer comprising:

a) a digital scale having a platform positioned to catch food and weigh it as it is sliced by the automatic electric food slicer; and

b) a digital program in a resident memory of a memory device associated with the slicer and the scale set to enable a user to program a desired weight of food to be cut, wherein once the slicer is started to automatically slice, the slicer automatically stops when the desired weight of food measured on the scale is sliced.

### BRIEF DESCRIPTION OF THE DRAWINGS

FIG. 1 is a perspective view of an automatic food slicer with digital scale.

FIG. 2 is a side view of an automatic food slicer with a digital scale.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention, and are not to be considered as limitation thereto. The term “means” preceding a present participle of an operation indicates a desired function for which there is one or more embodiments, i.e., one or more methods, devices, or apparatuses for achieving the desired function, and that one skilled in the art could select from these or their equivalent in view of the disclosure herein, and use of the term “means” is not intended to be limiting.

As used herein, the term “automatic electric food slicer” refers to a device also called a slicing machine, deli slicer, or simply a slicer, that is a tool used in butcher shops and delicatessens to slice meats, sausages, cheeses, and other deli and food products. Older models of meat slicers may be operated by crank, while newer ones generally use an electric motor to spin a circular blade to do the cuttings while moving a carriage back and forth past the rotating blade. A back and forth movement of the carriage can be manual or can be automatic till stopped by the user. In most versions of automated electric slicers, there is a platform on the slicer for catching the sliced food. While the slicer is traditionally a commercial apparatus, domestic use versions are also marketed. The platform in the present invention is used as a scale platform of a built-in digital scale and is associated with an automatic food slicer.

As used herein, the term “digital scale” refers to a commercial or home device used to measure the weight of ingredients and other food using a digital readout. Using a scale will result in a more accurate measurement of the ingredients than by measuring it by volume. Scales are available in manual and digital models. In the present invention; the digital scale is incorporated into the device with the platform for catching slices on the scale platform.

As used herein, the term “resident memory in a memory device associated with the slicer and the scale” refers to a digital program, i.e. software, that is present in a computer type memory device, associated with the slicer that stores the software program and executes it in such a manner that the digital program controls the actions of the slicer based on the results of weight shown on the digital scale. For example, if a customer wants 1 lb of sliced pastrami, the user enters the weight to the memory, using a digital graphic or manual interface and starts the slicer. The slicer automatically slices the meat until the amount of pastrami is weighed on the scale such that the amount is met or exceed by a single slice as measured by the digital scale. In one embodiment, the program will know the thickness of the slices based on the blade cutting thickness setting. In one embodiment, using this embodiment, the digital program stops the slicing when the next slice will exceed the desired weight selected on the slicer. In another such embodiment, the digital program can automatically adjust the thickness of slices to slice precisely the amount of food by weight.

### DRAWINGS

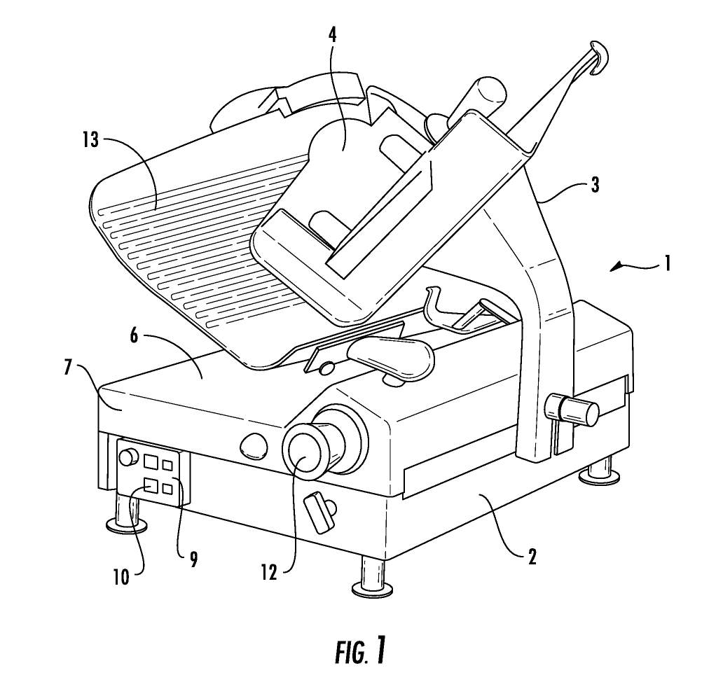

Now referring to the drawings, FIG. 1 is a perspective view of an automatic food slicer 1. This version of the slicer has base 2 and sliceable carriage 3. The carriage is automated such that the user can walk away once the slicing starts. Circular blade 4 is shown and when food is placed in the carriage and the carriage moved back and forth, slices of food are dispensed on the opposite side of the blade 4 and land on platform 6 which is the platform for digital scale 7. Digital program in resident memory 9 is situated with controls 10 to enter a desired weight and to program other functions such as controlling the thickness of the slices and determining how many slices to slice. In this view, there is slice thickness dial 12 which adjusts the blade relative to plate 13 in order to determine the thickness of each slice. The thickness can, in one embodiment, be manually set, and in another embodiment, the thickness is set by the digital program which controls a powered slice thickness adjustment.

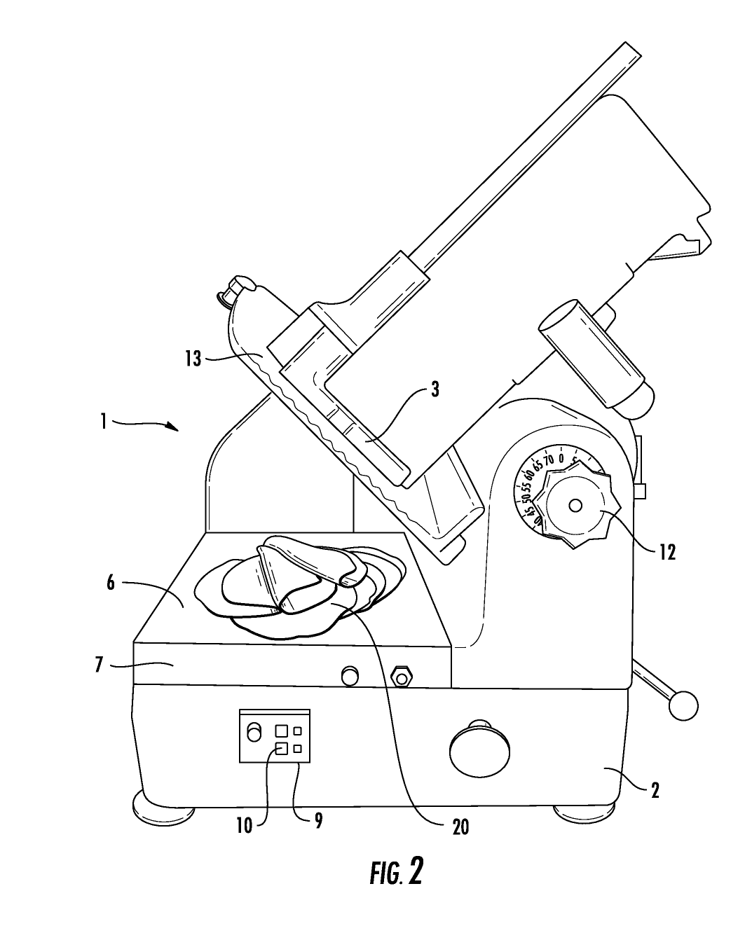

FIG. 2 is a side view of another embodiment of the slicer 1. In this view, one can see that the carriage 3 is holding down a piece of food 20. The view of the blade is blocked in this view and is just beyond the food 20. All other parts are as in FIG. 1.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. An automatic electric food slicer comprising:
a) a digital scale having a platform positioned to catch food and weigh it as it is sliced by the automatic electric food slicer; and
b) a digital program in a resident memory of a memory device associated with the slicer and the scale set to enable a user to program a desired weight of food to be cut, wherein once the slicer is started to automatically slice, the slicer automatically stops when the desired weight of food measured on the scale is sliced.

2. The automatic electric food slicer according to claim 1 where the digital program further calculates how many slices it will take to reach the desired weight and stops the slicing when the next slice will cause the sliced food to exceed the desired weight.

3. The automatic slicer according to claim 1 which further comprises the digital program adjusting the thickness of a food slice such that the desired weight is achieved exactly.
